(19) United States
(12) Patent Application Publication
(10) Pub. No.: US 2006/0090725 A1
(43) Pub. Date: May 4, 2006

(54) Devices for connecting canister air cleaners to carburetors of internal combustion engines

(76) Inventors: Paul W. Garvey, Kaukauna, WI (US); Timothy S. Thiel, Howards Grove, WI (US); Dan L. Bakke, Elkhart Lake, WI (US); Mark J. Ritger, Plymouth, WI (US)

Correspondence Address: QUARLES & BRADY LLP, 411 E. WISCONSIN AVENUE, SUITE 2040, MILWAUKEE, WI, 53202-4497, US

(21) Appl. No.: 11/252,656

(22) Filed: Oct. 18, 2005

Related U.S. Application Data
(60) Provisional application No. 60/620,492, filed on Oct. 20, 2004.

(51) Int. Cl. F02M 35/04

(52) U.S. Cl. 123/198 E

(57) ABSTRACT

An assembly of components for coupling an air filtration device to an engine is disclosed. The assembly includes an adapter component having first and second adapter ends, and a hose having first and second bends and first and second hose ends, where the first hose end is configured for being coupled to an output terminal of the air filtration device and the second hose end is capable of being coupled to the first adapter end of the adapter component. The adapter component further includes a straight tubular section leading up to the second adapter end so that, when the adapter component is assembled with respect to the engine, air is directed from the straight tubular section into the engine.

### CROSS REFERENCES TO RELATED APPLICATIONS

This application claims the priority benefit of U.S. Provisional Patent Application No. 60/620,492 filed on Oct. 20, 2004.

### STATEMENT REGARDING FEDERALLY SPONSORED RESEARCH

Not Applicable.

### FIELD OF THE INVENTION

The present invention relates to internal combustion engines that employ carburetors and air filters such as those provided in canister air cleaners for filtering air prior to its being provided to the carburetors.

### BACKGROUND OF THE INVENTION

Internal combustion engines typically employ carburetors that mix air with fuel to obtain a fuel-air mixture that is in turn provided to the engine cylinders for combustion. The air provided to the carburetors should be as clean as possible to achieve efficient engine operation, and consequently the air provided to the carburetors is typically first filtered by one or more air filtering devices before entry into the carburetors. In many such engines, the air filtering device(s) are contained within canister air cleaners that are mounted on the engines and coupled to the carburetors by way of various connection devices.

FIGS. 1 and 3 show exemplary Prior Art configurations of internal combustion engines having carburetors that receive filtered air provided from canister air cleaners by way of various connection devices. FIG. 1 in particular shows an exemplary horizontal-shaft internal combustion engine 2 (e.g., a Command Twin horizontal-shaft engine manufactured by Kohler Co. of Kohler, Wis.), at the top of which is mounted a conventional canister air cleaner 4. An output terminal 6 of the canister air cleaner 4 is coupled to a first carburetor air inlet 8 by way of a first set of connection devices 12. FIG. 3, in contrast to FIG. 1, shows an exemplary vertical-shaft internal combustion engine 10, on which is mounted the canister air cleaner 4. In this case, the output terminal 6 of the canister air cleaner 4 is coupled to a second carburetor air inlet 14 of the engine 10 by way of a second set of connection devices 16. As shown, the first carburetor air inlet 8 of the horizontal-shaft internal combustion engine 2 is along a top surface 18 of that engine, while the second carburetor air inlet 14 of the vertical-shaft internal combustion engine is along a side surface 20 of that engine.

Referring additionally to FIGS. 2 and 4, the first and second sets of connection devices 12 and 16 are shown in more detail in an exploded fashion, respectively. As shown particularly in FIG. 2, the first set of connection devices 12 includes seven components, namely, a cast aluminum elbow 22, a gasket 24, a cast aluminum adapter 26, a molded rubber hose 28, two screws 30, and a breather hose 32. The rubber hose 28 is molded to have a single bend and is for coupling the elbow 22 to the output terminal 6 of the canister air cleaner 4, while the two screws 30 are used to hold assembled a flange 34 of the elbow 22, the gasket 24 and the adapter 26 to the first carburetor air inlet 8. The breather hose fits on an outlet nipple 36 existing along the outer circumference of the gasket 24. Depending upon the engine, the canister air cleaner 4 can be mounted so that the output terminal 6 is oriented as shown in FIG. 1 or on the opposite side of the engine.

The first set of connection devices 12 allow for coupling of the air inlet 8 to the canister air cleaner 4 regardless of its orientation, since the elbow 22 can be rotated 180 degrees with respect to the air inlet 8 (and still be attached to the air inlet by way of the screws 30), and the rubber hose 28 can be rotated as necessary to connect the elbow in either position to the canister air cleaner. As for the second set of connection devices 16 shown in FIG. 4, these devices include a cast aluminum elbow 38, a gasket 40, an adapter 42, a rubber hose 44 (again molded to have only a single bend), a breather hose 46, and two washers and O-rings (not shown). Again, these connection devices can accommodate two different orientations of the canister air cleaner 4 with respect to the engine 20 based upon the rotational positioning of the elbow 38 with respect to the second carburetor air inlet 14 and the rotational positioning of the rubber hose 44 with respect to the elbow 38.

Although the first and second sets of connection devices 12,16 adequately communicate filtered air from the canister air filter 4 to the first and second carburetor air inlets 8 and 14, respectively, these connection devices nevertheless have certain disadvantages. First of all, the numbers of pieces employed by each of the first and second sets of connection devices 12,16 are relatively large, which renders those sets of connection devices fairly complicated and expensive to manufacture and assemble. Second, certain junctions among the different connection devices constitute potential air leakage paths, which are disadvantageous insofar as they potentially allow unfiltered air to bypass the canister air cleaners and directly enter the engine carburetors. In particular, the junctions between the gaskets 24,40 and the connection devices on either sides of the gaskets (e.g., the adapters 26 and 42 and the elbows 22 and 38, respectively) can potentially allow for air leakage.

Further, the first and second sets of connection devices 12,16 are disadvantageous insofar as, due to their large numbers of parts, it is difficult to assemble the connection devices with one another and to the carburetor air inlets 8,14 in a consistent manner that guarantees consistent air flow into the carburetors and thus consistent engine performance. As a result, during installation, significant efforts typically need to be made in order to properly align and calibrate the connection devices in relation to the carburetor air inlets 8,14 so that desired air flow occurs. Indeed, in certain embodiments, specialized features must be machined into the connection devices to facilitate their calibration in order to guarantee desired air flow.

Further, the difficulties associated with proper assembly and calibration of the connection devices are exacerbated when those devices are modified in their assembly and configuration to adjust for different orientations of the canister air cleaner 4 as discussed above. Reorientation of the elbows 22,38 in particular can affect the calibration of the connection devices so as to negatively affect desired air flow patterns into the engine carburetors.

It therefore would be advantageous if new connection device(s) could be designed for linking the output terminals of canister air cleaners (or other air filtration devices) with the air inlets of carburetors. It particularly would be advantageous if such new connection device(s) had fewer parts than the aforementioned devices, so as to reduce manufacturing and installation costs and difficulties, and so as to reduce or eliminate undesirable potential air leakage paths. Further, it would be advantageous if such new connection devices continued to make it possible to couple carburetors to canister air cleaners (or other air filtration devices) having multiple (at least two) orientations. Additionally, it would be advantageous if such new connection devices were designed so as to provide desired air flow patterns into the carburetors without requiring significant calibration efforts during installation or requiring special calibration features.

### SUMMARY OF THE INVENTION

The present inventor has recognized that canister air cleaners (or other air filtration devices) can be coupled to engine carburetors in a much simpler manner than the Prior Art embodiments discussed above, through the use of only a single adapter element configured to directly interface a carburetor air inlet, and a single rubber hose having two bends for linking the adapter element to the canister air cleaner. The exact adapter element varies depending upon whether it is to be used in relation to horizontal-shaft engines and vertical-shaft engines. For horizontal-shaft engines, the adapter element includes merely a single, generally-straight tubular section while, for vertical-shaft engines, the adapter element would include merely a single 90 degree tubular elbow. In each case, the portion of the adapter element to be mounted immediately adjacent to the carburetor element includes a relatively long, straight tubular section.

In each case, the number of parts needed to couple the canister air cleaner and engine carburetor is small, thus minimizing manufacturing and installation cost and reducing the possibility of air leakage. Further in each case, the adapter can be used to couple its respective carburetor air inlet to a canister air cleaner when the canister air cleaner is in either of two orientations, without adjusting the position of the adapter relative to the carburetor air inlet, through the use of an appropriate single rubber hose. Because the adapter need not be moved with respect to the carburetor air inlet to accommodate changes in positioning of the canister air cleaner, and because each adapter includes the relatively long, straight tubular section immediately adjacent to the carburetor air inlet, desired air flow patterns can be consistently provided into the carburetor without significant efforts at calibrating or aligning the connection devices with the carburetor air inlet, and without other special calibration features machined on the adapter elements.

In particular, the present invention relates to an assembly of components for coupling an air filtration device to an engine. The assembly includes an adapter component having first and second adapter ends, and a hose having first and second bends and first and second hose ends, where the first hose end is configured for being coupled to an output terminal of the air filtration device and the second hose end is capable of being coupled to the first adapter end of the adapter component. The adapter component further includes a straight tubular section leading up to the second adapter end so that, when the adapter component is assembled with respect to the engine, air is directed from the straight tubular section into the engine.

The present invention further relates to an internal combustion engine that includes an air filtering device, a carburetor, and a set of connection devices for coupling an output terminal of the air filtering device to an air inlet of the carburetor. The set of connection devices includes a hose and an adapter component, where the adapter is directly coupled to the air inlet and the hose is directly coupled between the output terminal and the adapter component.

### BRIEF DESCRIPTION OF THE DRAWINGS

FIG. 1 is a perspective view of an exemplary horizontal-shaft internal combustion engine on which is mounted a canister air cleaner, where the engine's carburetor and the air cleaner are coupled to one another by a first set of Prior Art connection devices;

FIG. 2 is a perspective, exploded view of the first set of connection devices of FIG. 1;

FIG. 3 is a perspective view of an exemplary vertical-shaft internal combustion engine on which is mounted a canister air cleaner, where the engine's carburetor and the air cleaner are coupled to one another by a second set of Prior Art connection devices;

FIG. 4 is a perspective, exploded view of the second set of connection devices of FIG. 3;

FIG. 5 is a perspective view of an exemplary horizontal-shaft internal combustion engine shown in cutaway on which is mounted a canister air cleaner, where the engine's carburetor and the air cleaner are coupled to one another by a first set of connection devices in accordance with one embodiment of the present invention;

FIG. 6 is a perspective, exploded view of the first set of connection devices of FIG. 5;

FIG. 7 is a perspective view of an adapter element of the first set of connection devices of FIGS. 5-6;

FIGS. 8-13 are elevation views of various surfaces of the adapter element of FIG. 7;

FIG. 14 is a cross-sectional view of the adapter element taken along line 14-14 of FIG. 9;

FIG. 15 is a perspective view of an exemplary vertical-shaft internal combustion engine shown in cutaway on which is mounted a canister air cleaner, where the engine's carburetor and the air cleaner are coupled to one another by a second set of connection devices in accordance with another embodiment of the present invention;

FIG. 16 is a perspective, exploded view of the second set of connection devices of FIG. 15;

FIG. 17 is a perspective view of an adapter element of the second set of connection devices of FIGS. 15-16;

FIGS. 18-23 are elevation views of various surfaces of the adapter element of FIG. 17; and

FIG. 24 is a cross-sectional view of the adapter element taken along line 24-24 of FIG. 19.

### DETAILED DESCRIPTION OF THE PREFERRED EMBODIMENT

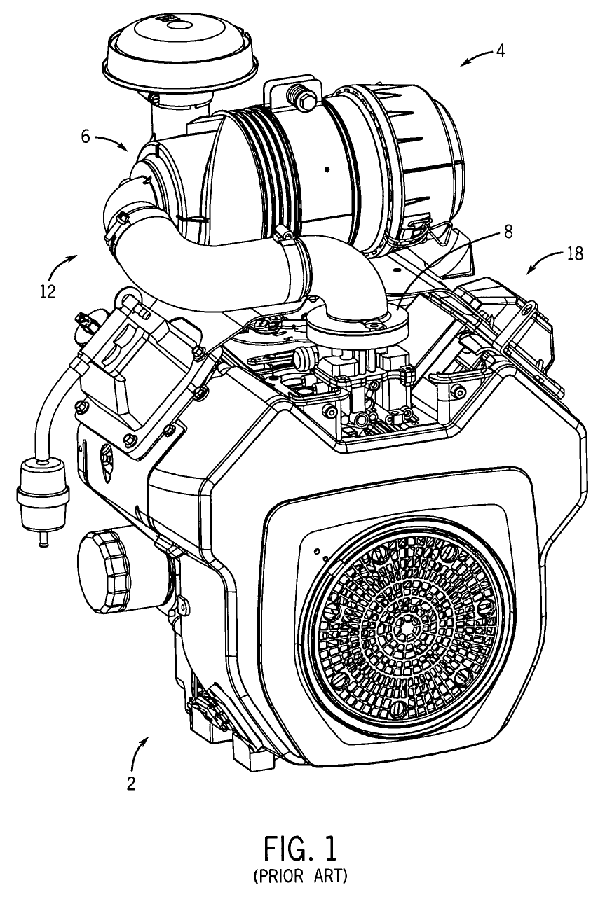

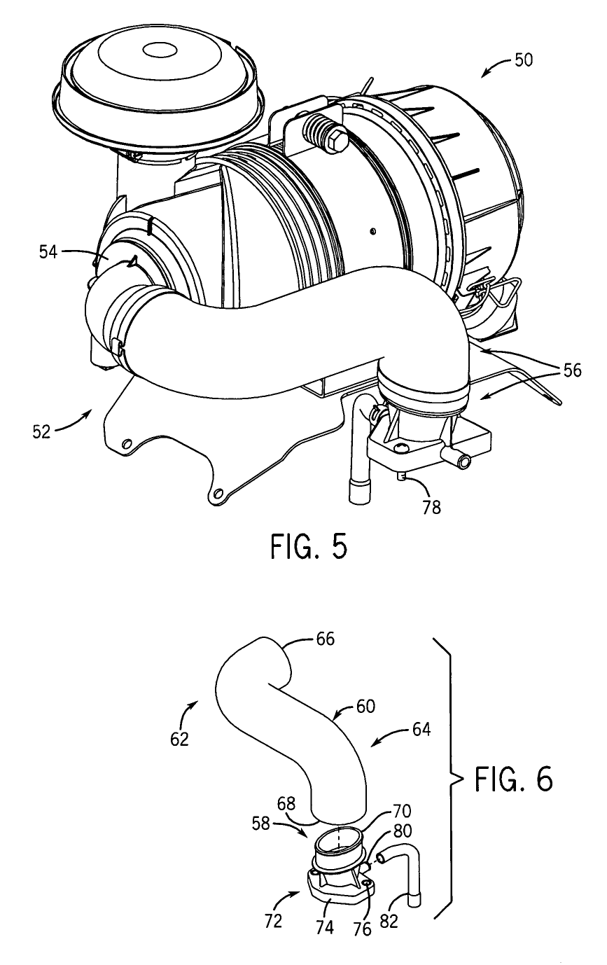

Referring to FIG. 5, a canister air cleaner 50 is shown to be mounted on an exemplary horizontal-shaft internal combustion engine 52 (shown in cutaway), which for example could be a Command Twin engine manufactured by Kohler Co. as discussed above with respect to FIG. 1. An air output terminal 54 of the air cleaner 50 is coupled to a carburetor air inlet (not shown) of the engine 52 by way of a first set of connection devices 56.

As shown more clearly in FIG. 6, the first set of connection devices 56 includes a first adapter element 58 and a first rubber hose 60. The rubber hose 60 can be made from any rubber-type or elastomeric or flexible material and, as shown, is molded to have first and second bends 62 and 64, respectively. In certain embodiments, the hose 60 has a 2″ inside diameter. A first end 66 of the hose 60 fits onto the air output terminal 54 of the air cleaner 50 while a second end 68 of the hose is configured to fit onto an oval-shaped end 70 of the adapter element 58.

More specifically, the oval-shaped end 70 of the adapter element 58 includes a lip 84 and a flange 86. In addition to being secured with respect to the oval-shaped end 70 simply by way of tension (due to being forced to take on an oval shape), the second end 68 of the rubber hose 60 is secured with respect to the oval-shaped end due to the additional pressure created by the lip 84 with respect to the rubber hose 60. The interaction of the second end 68 with the lip 84 not only serves to secure the rubber hose 60 to prevent the hose from falling off of the oval-shaped end 70 (e.g., when an additional clamp is placed on the hose), but also serves to prevent air leakage. As for the flange 86, that flange serves as a positive stop for the second end 68 of the rubber hose 60 as it is placed over the oval-shaped end 70. Additionally, each of the lip 84 and the flange 86 serve as stiffening ribs that help to maintain the oval shape of the oval-shaped end 70.

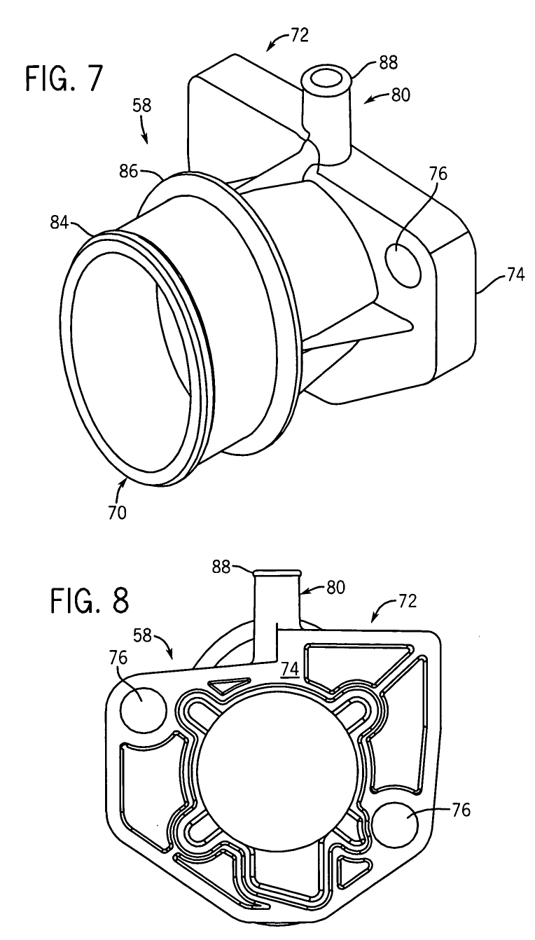

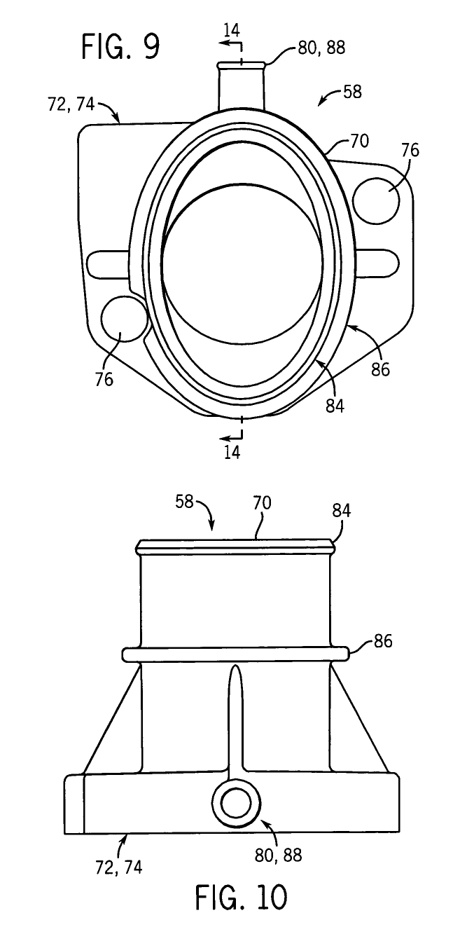

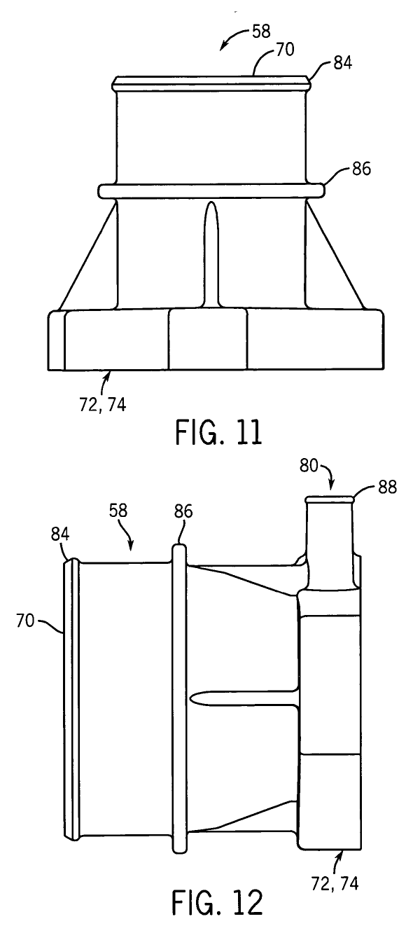

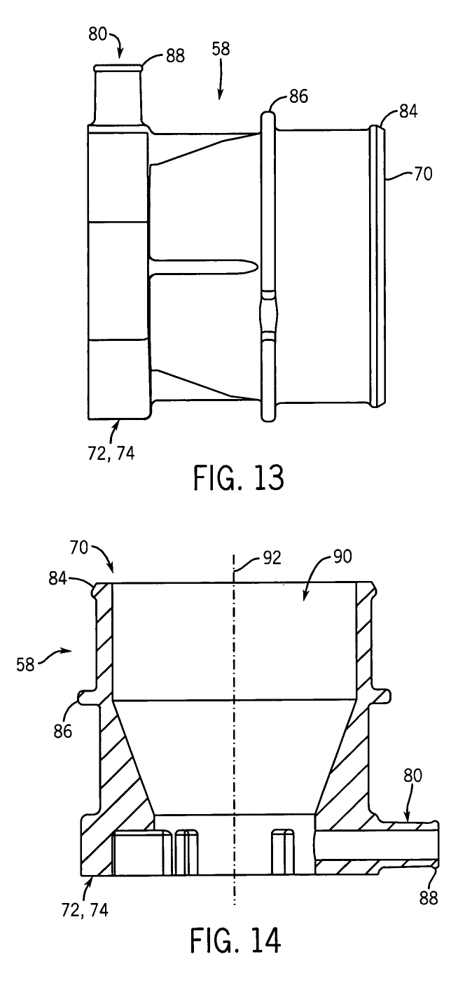

The adapter element 58 as shown in FIGS. 6-14 generally is a straight tubular section that extends from the oval-shaped end 70 to an opposite end 72 at which is located a flange 74 designed to interface the carburetor air inlet of the engine. The flange 74 includes two screw holes 76 through which can be placed two screws 78 (see FIG. 5), by which the flange 74 can be attached to a carburetor air inlet. The flange 74 can, depending upon the embodiment, directly interface the carburetor air inlet or interface the carburetor air inlet with a gasket (not shown) disposed in between. The attachment of the flange 74 to the carburetor air inlet by way of the screws 78 is facilitated by the oval-shape of the oval-shaped end 70, since screw holes 76 are not covered over by any portion of the end 70 (as best shown in FIG. 9).

The adapter element 58 further includes a nipple 80 to which can be affixed a breather tube 82. The nipple 80 includes a lip 88 that serves to retain the breather hose 82 in the same manner as the lip 84 serves to retain the rubber hose 60, thus further preventing the entry of undesirable material (e.g., dirt) from entering the adapter element 58 and then the carburetor. The adapter element 58 can be made from a variety of materials and, in one embodiment, is constructed from glass-filled polypropylene, which is satisfactory in view of the fact that the adapter element is unlikely to be exposed to extremely high temperatures and in view of its relatively high stiffness and relatively low cost.

Depending upon the orientation of the canister air cleaner 50 with respect to the engine 52, a different rubber hose 60 is used. In particular, when the canister air cleaner 50 is oriented as shown in FIG. 5, the hose 60 shown in FIGS. 5-6 is utilized; however, when the canister air cleaner 50 is oriented oppositely to that shown in FIG. 5 (e.g., by rotating the air cleaner 180 degrees), a hose having a shape being the mirror image of that shown in FIGS. 5-6 would be utilized.

Through the use of the appropriate hose depending upon the orientation of the air cleaner 50, the air cleaner can be coupled to the adapter element 58 and thus to the carburetor air inlet without any additional adjustment, rotation, or other movement of the adapter element relative to the carburetor air inlet. Therefore, the manner of assembly of the first set of connection devices 56 in relation to the canister air cleaner 50 and the engine carburetor is highly standardized. Further, adjustments in the orientation of the canister air cleaner are possible without impacting any calibration or positioning of the adapter element that might negatively or otherwise affect the manner of air flow into the carburetor.

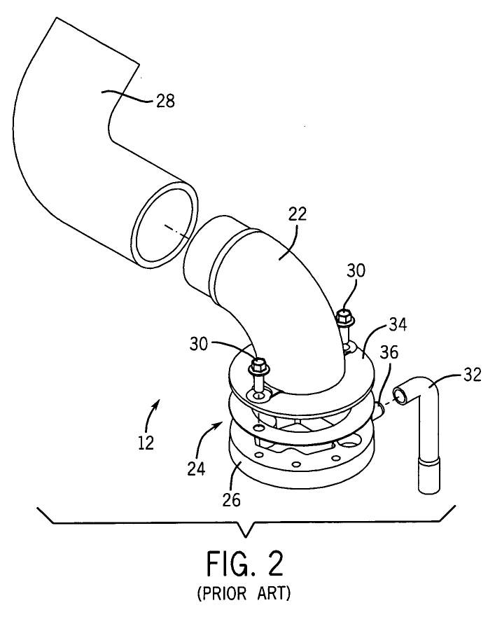

Additionally, because the first set of connection devices 56 includes only the adapter element 58 and the rubber hose 60 (and also the breather hose 82 and screws 78), the first set of connection devices has a minimal number of parts and consequently is relatively inexpensive and simple to manufacture and install relative to the Prior Art set of connection devices discussed with reference to FIGS. 1-2. Further, due to the minimization of parts, there is relatively little (if any) chance that unfiltered air can be communicated to the carburetor air inlet without being filtered by the canister air cleaner 50.

Referring particularly to FIG. 14, it is further evident that the inner cross-section of the adapter element 58 forms a tube 90. Although the tube 90 varies from having an oval cross-section at the oval-shaped end 70 to having a circular cross-section at the flange 74, the tube nevertheless follows a straight path along its central axis 92 and is relatively long (e.g., at least two inches long).

As a result of the tube being straight and relatively long, along with the fact that (as discussed above) the adapter element 58 is intended to be affixed to the carburetor air inlet in only one standardized manner, air flow into the carburetor air inlet from the adapter element proceeds in a consistent, straight manner as desired. That is, in many cases, neither significant calibration operations, nor any significant specialized machined features along the inside of the tube 90 or the flange 74 interfacing the carburetor air inlet, is necessary in order to achieve desired air flow into the carburetor air inlet. Further, to the extent that some calibration of the adapter element 58 in relation to the carburetor air inlet (or of the carburetor) is required in certain circumstances, that calibration need only be performed once even though the canister air cleaner is replaced or changed in its configuration at a later date.

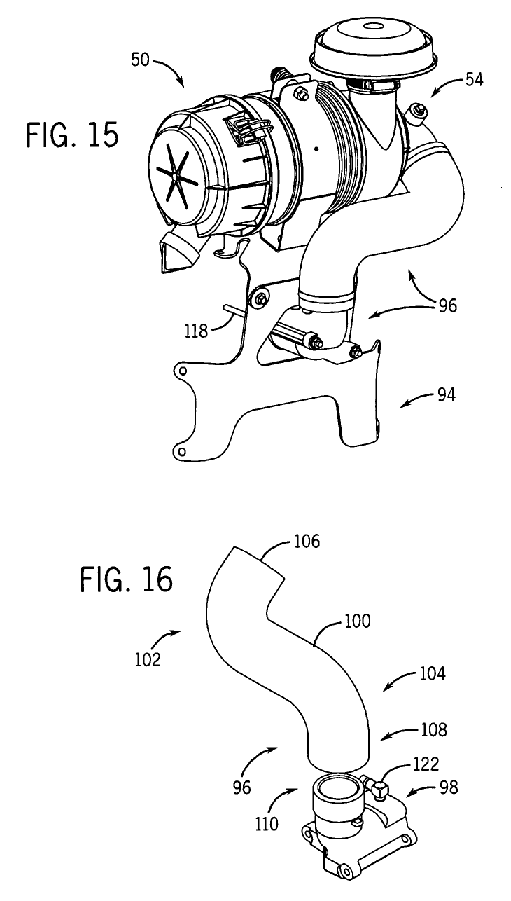

Turning to FIG. 15, an alternate exemplary embodiment of the present invention for implementation in combination with a vertical-shaft (rather than horizontal-shaft) internal combustion engine 94 is shown. More particularly as shown, the air output terminal 54 of the air cleaner 50 in the present embodiment is coupled to a carburetor air inlet (not shown) of the vertical-shaft internal combustion engine 94 by way of a second set of connection devices 96.

Referring further to FIG. 16, the second set of connection devices 96 includes a second adapter element 98 and a second rubber hose 100. The rubber hose 100 can be made from any rubber-type or elastomeric or somewhat-flexible material and, as shown, is molded to have first and second bends 102 and 104, respectively. A first end 106 of the hose 100 fits onto the air output terminal 54 of the air cleaner 50 while a second end 108 of the hose is configured to fit onto a circularly-shaped end 110 of the adapter element 98, which in the present embodiment (though not necessarily) has an outer diameter of 50.8 mm.

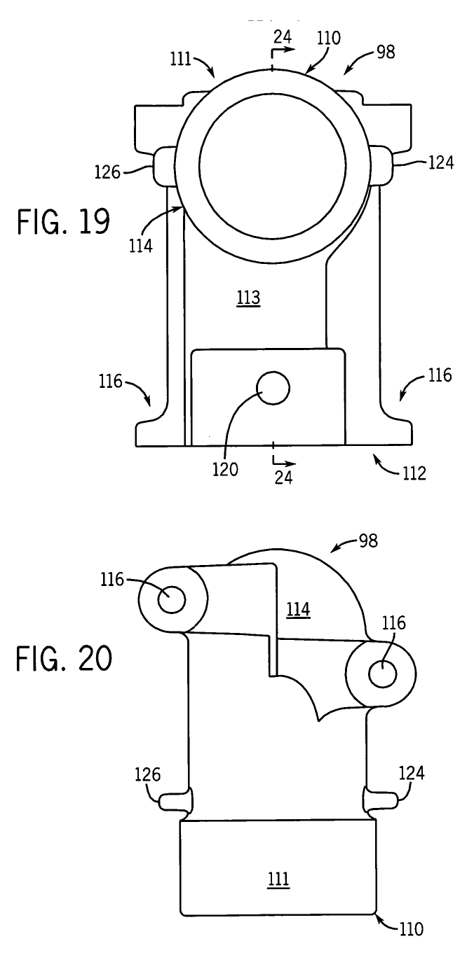

More specifically, the circularly-shaped end 110 of the adapter element 98 includes first and second ears 124 and 126, respectively (see, e.g., FIG. 19). The second end 108 of the rubber hose 60 is secured with respect to the circularly-shaped end 110 by way of tension (due to being forced over the end 110), which serves to prevent air leakage and serves to prevent the hose from falling off the end 110 (e.g., when a clamp is secured). The ears 124, 126 serve as positive stops for the second end 108 of the rubber hose 100 as it is placed over the circularly-shaped end 110.

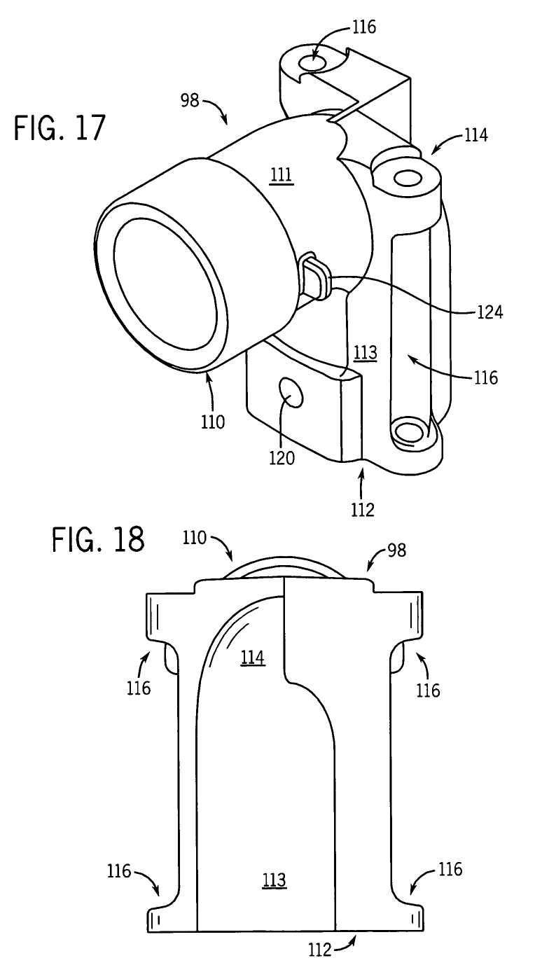

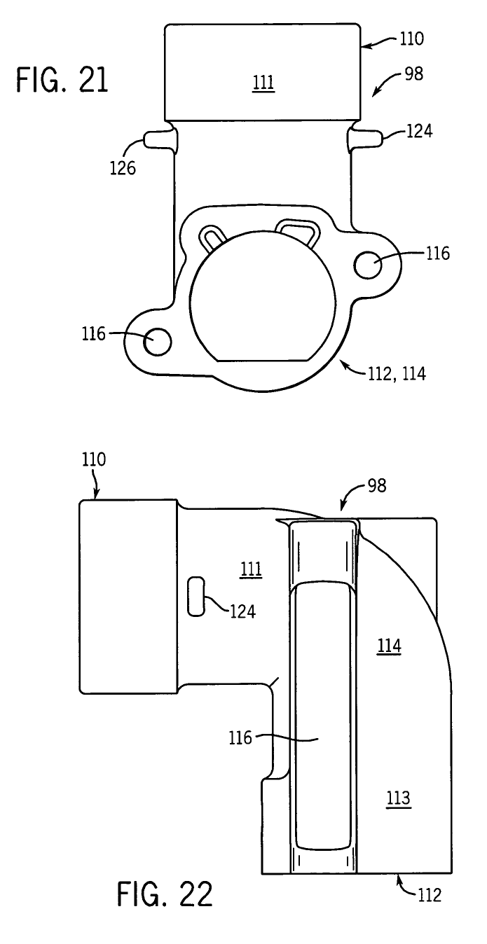

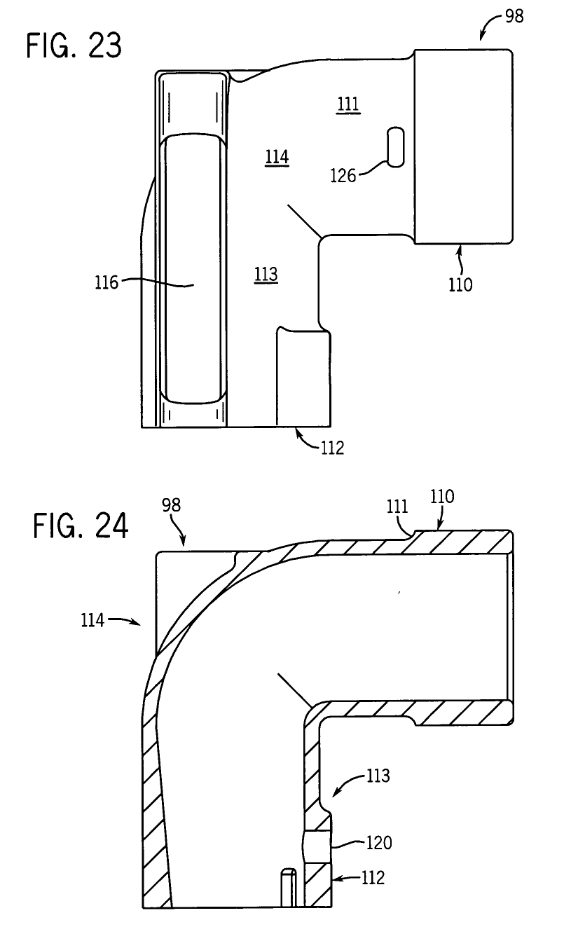

The adapter element 98 as shown in FIGS. 16-24 generally is a 90-degree elbow-shaped tube (or simply “elbow”). More specifically, the adapter element 98 has a first tubular segment 111 and a second tubular segment 113 that are connected with one another by a junction 114 (see, e.g., FIG. 24). The first tubular segment 111 extends from the circularly-shaped end 110 to the junction 114, while the second tubular segment 113 extends from the junction 114 to an opposite end 112 that is designed to interface the carburetor air inlet of the engine. In the present embodiment, the first and second tubular segments 111,113 have respective axes that are substantially perpendicular to one another, although in alternate embodiments, the respective axes of the two segments could be oriented in different manners (e.g., depending upon how the canister air cleaner is intended to be mounted onto the engine and how the rubber hose 100 is configured).

Along first and second sides 115 and 117 of the second tubular segment 113 are screw slots 116 through which can be placed two screws 118 (see FIG. 15), by which the opposite end 112 can be attached to a carburetor air inlet. The end 112 can, depending upon the embodiment, directly interface the carburetor air inlet or interface the carburetor air inlet with a gasket (not shown) disposed in between.

The adapter element 98 further includes an orifice 120 to which can be affixed a breather tube 122. In alternate embodiments, a nipple such as that discussed with reference to FIGS. 6-14 could be used in place of the orifice 120. The adapter element 98 can be made from a variety of materials and, in one embodiment, is constructed from cast aluminum, which is appropriate in view of the fact that this adapter element may be exposed to fairly high temperatures in view of its possible positioning above a muffler. In alternate embodiments, a plastic material capable of withstanding high temperatures could be employed.

Depending upon the orientation of the canister air cleaner 50 with respect to the engine 94, a different rubber hose 100 is used. In particular, when the canister air cleaner 50 is oriented as shown in FIG. 15, the hose 100 shown in FIG. 15 is utilized; however, when the canister air cleaner 50 is oriented oppositely to that shown in FIG. 15 (e.g., by rotating the air cleaner 180 degrees), a hose having the shape shown in FIG. 16 (namely, a shape that is the mirror image of that shown in FIGS. 15) would be utilized.

Through the use of the appropriate hose depending upon the orientation of the air cleaner 50, the air cleaner can be coupled to the adapter element 98 and thus to the carburetor air inlet without any additional adjustment, rotation, or other movement of the adapter element relative to the carburetor air inlet. Therefore, the manner of assembly of the second set of connection devices 96 in relation to the canister air cleaner 50 and the engine carburetor is highly standardized. Further, adjustments in the orientation of the canister air cleaner are possible without impacting any calibration or positioning of the adapter element that might negatively or otherwise affect the manner of air flow into the carburetor.

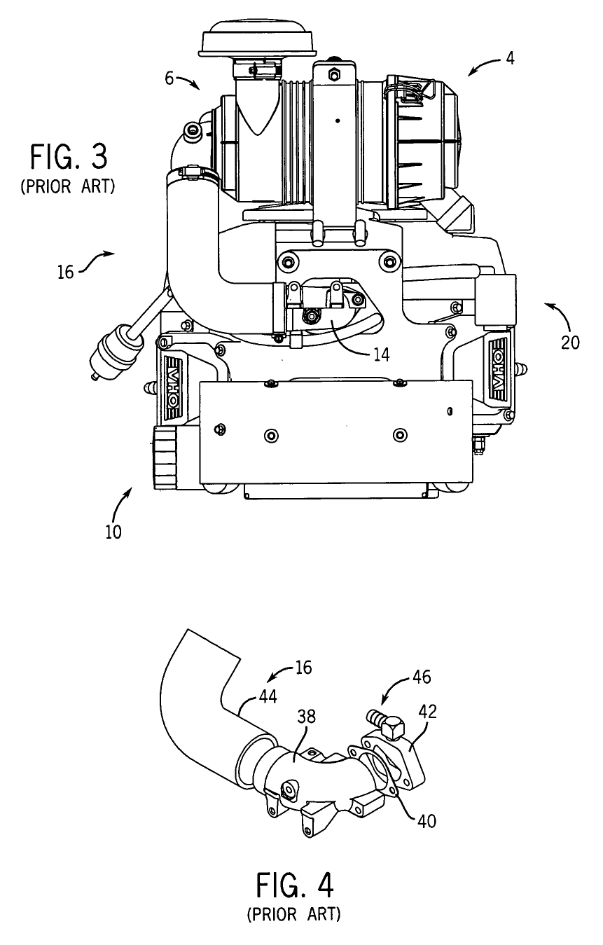

Additionally, because the second set of connection devices 96 includes only the adapter element 98 and the rubber hose 100 (and also the breather hose 122 and screws 118), the second set of connection devices has a minimal number of parts and consequently is relatively inexpensive and simple to manufacture and install relative to the Prior Art set of connection devices discussed with reference to FIGS. 3-4. Further, due to the minimization of parts, there is relatively little (if any) chance that unfiltered air can be communicated to the carburetor air inlet without being filtered by the canister air cleaner 50.

As discussed above, the tubular segment 113 is a relatively straight tubular section, and has a relatively long length (e.g., two or more inches). As a result of the tubular segment 113 being straight and relatively long, along with the fact that (as discussed above) the adapter element 98 is intended to be affixed to the carburetor air inlet in only one standardized manner, air flow into the carburetor air inlet from the adapter element proceeds in a consistent, straight manner as desired. That is, in many cases, neither significant calibration operations, nor any significant specialized machined features along the inside of the tubular segment 113 interfacing the carburetor air inlet, is necessary in order to achieve desired air flow into the carburetor air inlet. Further, to the extent that some calibration of the adapter element 98 in relation to the carburetor air inlet is required in certain circumstances, that calibration need only be performed once even though the canister air cleaner is replaced or changed in its configuration at a later date.

While the foregoing specification illustrates and describes the preferred embodiments of this invention, it is to be understood that the invention is not limited to the precise construction herein disclosed. The invention can be embodied in other specific forms without departing from the spirit or essential attributes. For example, the present inventive connection devices could potentially be employed for the purpose of coupling engine carburetors with other air filtration devices rather than merely canister air cleaners as shown. Also, certain features could be varied from those shown depending upon the embodiment. For example, in some embodiments, the oval-shaped end 70 could be replaced with a circularly-shaped end. Accordingly, reference should be made to the following claims, rather than to the foregoing specification, as indicating the scope of the invention.

We claim:

1. An assembly of components for coupling an air filtration device to an engine, the assembly of components comprising:
an adapter component having first and second adapter ends; and
a hose having first and second bends and first and second hose ends, wherein the first hose end is configured for being coupled to an output terminal of the air filtration device and the second hose end is capable of being coupled to the first adapter end of the adapter component;
wherein the adapter component further includes a straight tubular section leading up to the second adapter end so that, when the adapter component is assembled with respect to the engine, air is directed from the straight tubular section into the engine.

2. The assembly of claim 1,.wherein the straight tubular section extends from the first end to the second end of the adapter component.

3. The assembly of claim 2, wherein the engine is a horizontal-shaft internal combustion engine.

4. The assembly of claim 1, wherein the straight tubular section extends from a 90-degree junction to the second end, and the adapter component

5. The assembly of claim 4, wherein the engine is a vertical-shaft internal combustion engine.

6. The assembly of claim 1, wherein the adapter component includes at least one extension intended to facilitate coupling of at least one of the hose and an additional breather hose to the adapter component.

7. The assembly of claim 1, wherein the first adapter end is oval-shaped, and the second hose end is stretched over the first adapter end.

8. An internal combustion engine comprising:
an air filtering device;
a carburetor; and
a set of connection devices for coupling an output terminal of the air filtering device to an air inlet of the carburetor, the set of connection devices including
a hose; and
an adapter component,
wherein the adapter is directly coupled to the air inlet and the hose is directly coupled between the output terminal and the adapter component.

9. The internal combustion engine of claim 8, in which the adapter component includes a first adapter end coupled to the hose and a second adapter end coupled to the air inlet, and the a hose has first and second bends and first and second hose ends, wherein the first hose end is coupled to the output terminal and the second hose end is coupled to the first adapter end of the adapter component, wherein the adapter further includes a straight tubular section leading up to the second adapter end so that, air is directed from the straight tubular section into the engine.

10. The internal combustion engine of claim 9, wherein the straight tubular section extends from the first end to the second end of the adapter.

11. The internal combustion engine of claim 8, wherein the engine is a horizontal-shaft internal combustion engine.

12. The internal combustion engine y of claim 9, wherein the straight tubular section extends from a 90-degree junction to the second end, and the adapter component.

13. The internal combustion engine of claim 8, wherein the engine is a vertical-shaft internal combustion engine.

14. The internal combustion engine of claim 8, wherein the adapter component includes at least one extension intended to facilitate coupling of at least one of the hose and an additional breather hose to the adapter component.

15. The internal combustion engine of claim 9, wherein the adapter component includes an oval-shaped adapter end, and a hose end is stretched over the adapter end.
